(19) United States
(12) Patent Application Publication
(10) Pub. No.: US 2025/0201830 A1
(43) Pub. Date: Jun. 19, 2025

(54) ELECTRODE MIXTURE AND SOLID-STATE BATTERY

(71) Applicant: TOYOTA JIDOSHA KABUSHIKI KAISHA, Toyota-shi (JP)

(72) Inventor: Hideaki WATANABE, Nisshin-shi (JP)

(73) Assignee: TOYOTA JIDOSHA KABUSHIKI KAISHA, Toyota-shi (JP)

(21) Appl. No.: 18/921,930

(22) Filed: Oct. 21, 2024

(30) Foreign Application Priority Data
Dec. 19, 2023 (JP) 2023-213807

(51) Int. Cl. H01M 4/46; H01M 4/36; H01M 4/62; H01M 10/0562

(52) U.S. Cl. CPC H01M 4/463; H01M 4/366; H01M 4/625; H01M 10/0562; H01M 2300/0068

(57) ABSTRACT

An electrode mixture that can achieve both a low resistance and a high volumetric energy density, and a solid-state battery including such an electrode mixture. The electrode mixture includes a layered rock salt type electrode active material, a sulfide solid electrolyte, and a conductive aid. A D50 particle size of the layered rock salt type electrode active material is 2.5 μm or more and 4.5 μm or less, and a ratio of a mass of the conductive aid to a mass of the sulfide solid electrolyte is 2.0% by mass or more and 11.0% by mass or less.

### FIELD

The present disclosure relates to an electrode mixture and a solid-state battery.

### BACKGROUND

To improve various characteristics of batteries, a particle size of an electrode active material may be considered.

For example, PTL 1 discloses an all-solid-state secondary battery with a positive electrode, a negative electrode, and a solid electrolyte layer. The positive electrode has a molded body of a positive electrode mixture comprising a positive electrode active material, a conductive aid, and a sulfide-based solid electrolyte, and the positive electrode active material has a Nb-containing oxide layer on its surface. In the all-solid-state secondary battery, a particle size distribution of the positive electrode active material has a first frequency peak and a second frequency peak, and the first frequency peak is in the range of 1 μm to 8 μm, and the second frequency peak is in the range of 15 μm to 35 μm.

### CITATION LIST

### Patent Literature

[PTL 1] Japanese Unexamined PCT Publication (Kokai) No. 2022-125392

### SUMMARY

### Technical Problem

Generally, it is preferable for batteries to have a low resistance value and a high volumetric energy density.

An object of the present disclosure is to provide an electrode mixture that can achieve both a low resistance and a high volumetric energy density, and a solid-state battery comprising such an electrode mixture.

### Solution to Problem

The present disclosers have discovered that the above object can be achieved by the following means. cl Aspect 1

An electrode mixture, comprising a layered rock salt type electrode active material, a sulfide solid electrolyte, and a conductive aid,
wherein a D50 particle size of the layered rock salt type electrode active material is 2.5 μm or more and 4.5 μm or less, and
wherein a ratio of a mass of the conductive aid to a mass of the sulfide solid electrolyte is 2.0% by mass or more and 11.0% by mass or less.

### Aspect 2

The electrode mixture according to Aspect 1, wherein a ratio of a mass of the sulfide solid electrolyte to a total mass of the layered rock salt type electrode active material and the sulfide solid electrolyte is 10% by mass or more and 20% by mass or less.

### Aspect 3

The electrode mixture according to Aspect 1 or 2, wherein the conductive aid is fibrous carbon.

### Aspect 4

The electrode mixture according to any one of Aspects 1 to 3, wherein the layered rock salt type electrode active material has a composition shown in a following formula (1):

Liₐ(NiₓCo_{y}M_{1-x-y})O₂ (1)

(in the formula (1), a, x, y and 1-x-y are numbers that meet 1.00≤a≤1.20, 0.30≤x≤0.90, 0.10≤y≤0.35, and 0 1-x-y≤0.10, respectively, and M is a metallic element selected from aluminum and manganese).

### Aspect 5

The electrode mixture according to any one of Aspects 1 to 3, wherein the layered rock salt type electrode active material comprises lithium, nickel, aluminum, and manganese.

### Aspect 6

A solid-state battery,
wherein the solid-state battery comprises a positive electrode current collector layer, a positive electrode active material layer, a solid electrolyte layer, a negative electrode active material layer, and a negative electrode current collector layer in this order, and
wherein either one of the positive electrode active material layer and the negative electrode active material layer comprise the electrode mixture according to any one of Aspects 1 to 5.

### Aspect 7

The solid-state battery according to Aspect 6, wherein the positive electrode active material layer comprises the electrode mixture according to any one of Aspects 1 to 5.

### Aspect 8

The solid-state battery according to Aspect 7, wherein the negative electrode active material layer comprises a negative electrode active material having a silicon element.

### Advantageous Effects of Invention

According to the present disclosure, an electrode mixture that can achieve both a low resistance and a high volumetric energy density, and a solid-state battery comprising such an electrode mixture can be provided.

### BRIEF DESCRIPTION OF DRAWINGS

FIG. 1 is a schematic cross-sectional view showing an example of a solid-state battery of the present disclosure.

FIG. 2 is a histogram showing the distance between the positive electrode active materials in the batteries of the Examples.

FIG. 3 is a histogram showing the distance between the positive electrode active materials in the batteries of Comparative Examples.

### DESCRIPTION OF EMBODIMENTS

Hereinafter, embodiments of the present disclosure will be described in detail. It should be noted that the present disclosure is not limited to the following embodiments, and various modifications can be made thereto within the scope of the disclosure.

### Electrode Composite Materials

The electrode mixture of the present disclosure comprises a layered rock salt type electrode active material, a sulfide solid electrolyte, and a conductive aid. A D50 particle size of the layered rock salt type electrode active material is 2.5 μm or more and 4.5 μm or less, and a ratio of a mass of the conductive aid to a mass of the sulfide solid electrolyte is 2.0% by mass or more and 11.0% by mass or less.

In order to increase a volumetric energy density of batteries, a resistance value of batteries increase when a content of a conductive aid is reduced in an electrode mixture.

In this regard, the present disclosers unexpectedly have found that a battery with a low resistance value and a high volumetric energy density can be obtained by reducing a ratio of a conductive aid to a sulfide solid electrolyte and decreasing a particle size of an electrode active material. The reason for this is not intended to be bound by any theory, but it is presumed as follows. That is, when considering an electronic conductivity of an electrode mixture, an electronic conductivity of an electrode active material is considered to be low compared with an electron conductivity of a conductive aid. On the other hand, it is thought that when a particle size of an electrode active material is small, the distance between the electrode active materials becomes short, and therefore a good conductive path between the electrode active materials is likely to be formed in an electrode mixture. Therefore, when a particle size of an electrode active material is small, even if a part of a conductive aid in an electrode mixture is replaced with an electrode active material with lower electronic conductivity, that is, even if a ratio of a conductive aid to a sulfide solid electrolyte is reduced, it is considered that an electronic conductivity is not extremely reduced, and as a result, an increase of a resistance value is suppressed. Further, it is considered that a volumetric energy density of a battery is improved by decreasing a content of a conductive aid, that is, by relatively increasing a content of an electrode active material.

The “electrode mixture” relating to the present disclosure means a composition that can constitute an electrode active material layer as-is or by further containing additional components. Further, the “electrode mixture slurry” relating to the present disclosure means a slurry that comprises a dispersion medium in addition to the “electrode mixture” and can thereby be applied and dried to form an electrode active material layer.

The electrode mixture of the present disclosure comprises a layered rock salt type electrode active material, a sulfide solid electrolyte, and a conductive aid, and optionally comprises a binder.

The D50 particle size of the layered rock salt type electrode active material is 2.5 μm or more and 4.5 μm or less. The D50 particle size may be 2.5 μm or more and 4.0 μm or less. Also, the D50 particle size may be 2.6 μm or more, 2.7 um or more, 2.8 μm or more, 2.9 μm or more, or 3.0 μm or more, and may be 3.8 μm or less, 3.6 μm or less, 3.5 μm or less, 3.4 μm or less, 3.3 μm or less, 3.2 μm or less, 3.1 μm or less, or 3.0 μm or less.

In the present disclosure, the D50 particle size of the layered rock salt type electrode active material can be measured as follows: a particle size distribution of the layered rock salt type electrode active material is obtained using a laser diffraction scattering particle size distribution measuring device LA-920 (manufactured by Horiba, Ltd.); and the D50 particle size is calculated as a particle size such that when the particle size is divided into a larger side and a smaller side from a certain particle size in the obtained particle size distribution, the number of particles of the larger side and smaller side is equal.

The ratio of the mass of the conductive aid to the mass of the sulfide solid electrolyte is 2.0% by mass or more and 11.0% by mass or less. The ratio may be 3.0% by mass or more, 4.0% by mass or more, 5.0% by mass or more, 6.0% by mass or more, or 7.0% by mass or more, and may be 10.0% by mass or less, 9.0% by mass or less, 8.0% by mass or less, 7.0% by mass or less, 6.0% by mass or less, 5.0% by mass or less, or 4.0% by mass or less.

The ratio of the mass of the sulfide solid electrolyte to the total mass of the layered rock salt type electrode active material and the sulfide solid electrolyte may be 10% by mass or more and 20% by mass or less. This ratio may be 12% by mass or more, 14% by mass or more, or 16% by mass or more, and may be 18% by mass or less, 16% by mass or less, 14% by mass or less, 12% by mass or less, or 10% by mass or less.

### Layered Rock Salt Type Electrode Active Material

The layered rock salt type electrode active material may have a composition shown in a following formula (1):

Liₐ NiₓCo_{y}M_{1-x-y})O₂ (1)

(in the formula (1), a, x, y and 1-x-y are numbers that meet 1.00≤a≤1.20, 0.30≤x≤0.90, 0.10 ≤y≤0.35, and 0<1-x-y≤0.10, respectively, and M is a metallic element selected from aluminum and manganese).

The layered rock salt type electrode active material may be, in particular, an NCA-based positive electrode active material in which M is aluminum.

The layered rock salt type electrode active material may comprise lithium, nickel, aluminum, and manganese.

A method for manufacturing a layered rock salt type electrode active material is not particularly limited, but can be manufactured, for example, by the following method. That is, first, an alkaline aqueous solution is prepared. Then, nickel, cobalt, and a metallic element M, or nickel, cobalt, aluminum, and manganese are dissolved in water to prepare a mixed aqueous solution. Then, the mixed aqueous solution is dropped at a predetermined rate into the alkaline aqueous solution, and the mixture is stirred at a predetermined rate to form a precipitate, and the precipitate is dried to obtain a precursor. Further, a layered rock salt type electrode active material can be obtained by mixing the precursor and a lithium compound and baking them.

The D50 particle size of the layered rock salt type electrode active material can be adjusted, for example, by pH of the alkaline aqueous solution, the dropping rate of the mixed aqueous solution, and the stirring rate of the aqueous solution after dropping the mixed aqueous solution.

With respect to the present disclosure, an “electrode active material” can be used both as a “positive electrode active material” and as a “negative electrode active material”, and is particularly used as a “positive electrode active material”

When a layered rock salt type electrode active material is used as a positive electrode active material, a material exhibiting a base potential with respect to the layered rock salt type electrode active material can be used as a negative electrode active material. As such a negative electrode active material, a known active material may be used. For example, when constructing a lithium ion battery, silicon-based active materials such as a silicon element, a silicon alloy, or a silicon oxide; carbon-based active materials such as graphite or hard carbon; various oxide-based active materials such as lithium titanate; metallic lithium and a lithium alloy can be used as a negative electrode active material. The negative electrode active material may be, for example, particulate, and the size thereof is not particularly limited.

### Sulfide Solid Electrolyte

Examples of the sulfide solid electrolyte include, but are not limited to, sulfide amorphous solid electrolytes, sulfide crystalline solid electrolytes, and argyrodite-type solid electrolytes. Specific examples of the sulfide solid electrolyte can include, but are not limited to, Li₂S—P₂S₅-based (such as Li₇P₃S₁₁, Li₃PS₄, and Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (such as Li₁₃GeP₃S₁₆ and Li₁₀GeP₂S₁₂), LiI—Li₂S—P₂O₅, LiI—Li₃PO₄—P₂S₅, and Li₇₋ₓPS₆₋ₓClₓ; and combinations thereof.

The sulfide solid electrolyte may be a glass or a crystallized glass (glass ceramic).

### Conductive Aid

The conductive aid is not particularly limited, but may be a carbon material. Carbon materials may be particulate carbon such as acetylene black (AB), and ketchen black (KB), and fibrous carbon such as single-walled carbon nanotube (SWCNT), multi-walled carbon nanotube (MWCNT), and vapor-grown carbon fiber (VGCF). When the conductive agent is fibrous carbon, it is easy to contribute to the formation of a good conduction path between the electrode active materials in the electrode composite.

### Binder

The binder is not particularly limited as long as it is commonly used as a binder for electrode active material layers. Examples of the binder include, but are not limited to, materials such as, polyvinylidene fluoride-hexafluoropropylene copolymer (PVDF-co-HEP), polyvinylidene fluoride (PVDF), polytetrafluoroethylene (PTFE), polyacrylic acid, polyacrylonitrile, polymethyl methacrylate, polyvinyl alcohol, polyvinyl pyrrolidone, carboxymethyl cellulose (CMC), hydroxypropyl cellulose, regenerated cellulose, polyethylene, polypropylene, starch, butadiene rubber (BR), styrene butadiene rubber (SBR), fluor rubber or combinations thereof. The binder may in particular be in the form of colloidal particles.

The method for manufacturing the electrode mixture of the present disclosure is not particularly limited. For example, a method is exemplified in which a layered rock salt type electrode active material, a sulfide solid electrolyte, and a conductive aid, and optionally a binder are mixed in a dispersion medium to obtain a slurry-like electrode mixture (electrode mixture slurry).

### Solid-State Battery

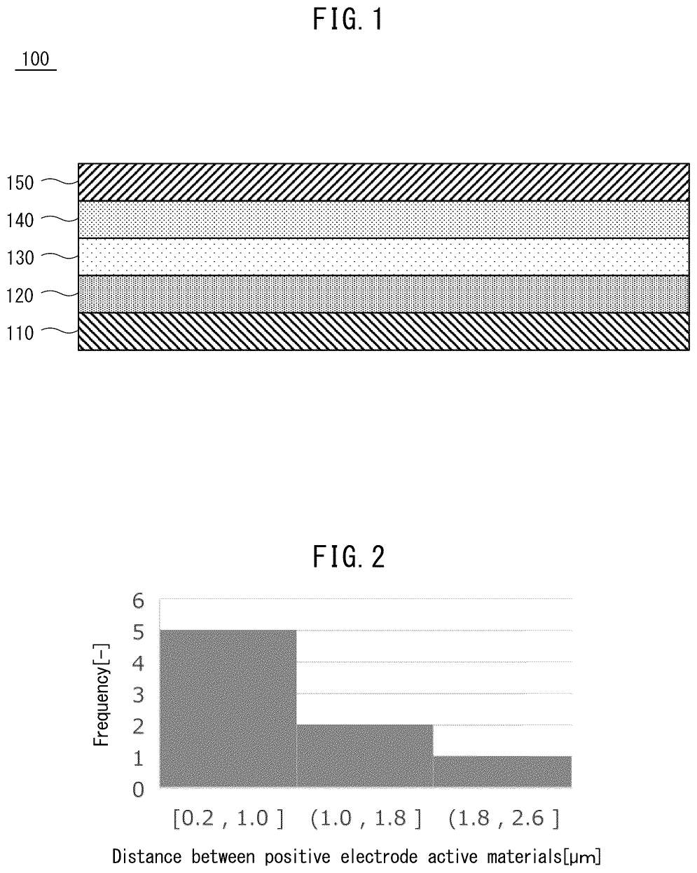

As shown in FIG. 1, the solid-state battery 100 of the present disclosure comprises a positive electrode current collector layer 110, a positive electrode active material layer 120, a solid electrolyte layer 130, a negative electrode active material layer 140, and a negative electrode current collector layer 150 in this order, and either one of the positive electrode active material layer and the negative electrode active material layer comprise the electrode mixture of the present disclosure.

It should be noted that the “solid-state battery” relating to the present disclosure means a battery using at least a solid electrolyte as the electrolyte, and therefore the solid-state battery may use a combination of a solid electrolyte and a liquid electrolyte as the electrolyte. In addition, the solid-state battery of the present disclosure may be an all-solid-state battery, i.e., a battery using only a solid electrolyte as the electrolyte.

### Positive Electrode Current Collector Layer and Negative Electrode Current Collector Layer

As the positive electrode current collector layer and the negative electrode current collector layer are not particularly limited as long as they can be used as current collector layers of batteries. For example, when configuring a lithium ion battery, aluminum foil, copper foil, and the like may be used.

### Positive Electrode Active Material Layer

The positive electrode active material layer comprises a positive electrode mixture comprising a positive electrode active material and optionally a solid electrolyte, a conductive aid, and a binder. In particular, the positive electrode mixture may be the electrode mixture of the present disclosure. In other words, the positive electrode active material layer may comprise the electrode mixture of the present disclosure. For the electrode mixture of the present disclosure, the above description regarding the electrode mixture of the present disclosure can be referred to.

### Negative Electrode Active Material Layer

The negative electrode active material layer comprises a negative electrode mixture comprising a negative electrode active material and optionally a solid electrolyte, a conductive aid, and a binder. When the positive electrode active material layer comprises the electrode mixture of the present disclosure, the negative electrode active material layer comprises a negative electrode active material having a silicon element. In this case, for the solid electrolyte, the conductive aid, and the binder, the above description regarding the electrode mixture of the present disclosure can be referred to.

### Solid Electrolyte Layer

The solid electrolyte layer comprises a solid electrolyte, and optionally comprises a conductive aid and a binder. For the solid electrolyte, the conductive aid, and the binder, the above description regarding the electrode mixture of the present disclosure can be referred to.

As a method for manufacturing the solid-state battery of the present disclosure, a method including forming an electrode active material layer containing the electrode mixture of the present disclosure is exemplified.

As a method for forming the electrode active material layer, a method for providing an electrode mixture slurry comprising the electrode mixture and a dispersion medium, and applying the electrode mixture slurry to a base material and drying and removing the dispersion medium.

### EXAMPLES

### Production Example 1

### <Preparation of Layered Rock Salt Type Positive Electrode Active Material>

In a reactor, 2.5 L of 5 g/L ammonia aqueous solution was prepared, and an initial aqueous solution was prepared using a sodium hydroxide aqueous solution so that pH was 11.5 on the basis of a liquid temperature of 25° C., while keeping a temperature in the reactor at 40° C. And, nickel sulfate (NiSO₄), cobalt sulphate (CoSO₄) and aluminum sulphate (Al₂(SO₄)₃) were dissolved in pure water so that Ni:Co:Al=0.82:0.15:0.03 (mol) to prepare a 2.0 mol/L mixed aqueous solution. The mixed aqueous solution was added dropwise to the initial aqueous solution of the reactor at a predetermined dropping rate, and the mixture was stirred at a predetermined stirring rate to form a precipitate. The collected slurry was filtered, washed, and dried to obtain an electrode active material precursor. After mixing the lithium carbonate (Li₂CO₃) with the obtained electrode active material precursor so that Li:Ni+Co+Al=1.10:1.00 (mol), the mixture was baked at 750° C. for 10 h in an oxygen atmosphere to a obtain a layered rock salt type electrode active material of Production Example 1.

### Production Examples 2 and 3 and Comparative Production Examples of 1 and 2

The layered rock salt type electrode active material of Production Examples 2 and 3 and Comparative Production Examples 1 and 2 were obtained in the same manner as Production Example 1, except that the electrode active material precursor was prepared by changing pH of the initial aqueous solution, the dropping rate, and the stirring rate.

The layered rock salt type electrode active material obtained in each production example was used as a positive electrode active material.

### Comparative Example 1

### Preparation of Coated Positive Electrode Active Material

10.8 g of metaphosphoric acid (HPO₃) (manufactured by Fujifilm Wako Pure Chemical Corporation) was dissolved in 166.0 g ion-exchanged water. Thereafter, lithium hydroxide monohydrate (LiOH·H₂O) was added so that Li/P (mol) was 0.45 to prepare a coating liquid. 53.7 g of the coating liquid was added to 50.0 g of the layered rock salt type electrode active material of Comparative Production Example 1 as a positive electrode active material to obtain a slurry. A coated positive electrode active material was obtain by spray drying the obtained slurry.

<Preparation of Positive Electrode Mixture>

The obtained coated positive electrode active material and the sulfide solid electrolyte (Li₂S-P₂S₅-based glass ceramics containing LiI, D50=0.8 μm) were weighed so that a volume ratio was 80:20. Further, when the coated positive electrode active material was 100 parts by mass, vapor grown carbon fiber (VGCF) as a conductive aid was weighed so as to be 0.2 parts by mass, and the butadiene rubber as a binder was weighed so as to be 0.4 parts by mass. Each weighed component was charged into tetralin. Then, these were mixed and further sufficiently dispersed by an ultrasonic homogenizer (manufactured by SMT, UH-50) to obtain a slurry-like positive electrode mixture (positive electrode mixture slurry).

### Preparation of Positive Electrode Laminated Body

The obtained positive electrode mixture slurry was coated on an aluminum (Al) foil as a positive electrode current collector, and the coated film was dried at 100° C. for 30 min to form a positive electrode active material layer on the positive electrode current collector. Thereafter, the laminated body consisting of the positive electrode current collector and the positive electrode active material layer was punched out into a size of 1 cm² to obtain a positive electrode laminated body.

### Preparation of Negative Electrode Mixture

A sulfide solid electrolyte (Li₂S—P₂S₅-based glass ceramics containing Lil, D50=0.8 μm), 1% by mass of VGCF as a conductive aid, 2% by mass of butadiene rubber as a binder, and heptane were put into a kneading container of FILMIX device (manufactured by Primix, type 30-L), and the mixture was stirred at 20000 rpm for 30 min. Then, the negative electrode active material (Li₄ Ti₅ O₁₂ particle, D50=1 μm) and the solid electrolyte were weighed so that a volume ratio was 7:3. These were put into the kneading container, and stirred at 15000 rpm for 60 min using FILMIX device to obtain a negative electrode mixture slurry.

### Preparation of Negative Electrode Laminated Body

The obtained negative electrode mixture slurry was coated on a copper foil as a negative electrode current collector, and the coated film was dried at 100° C. for 30 min to form a negative electrode active material layer on a negative electrode current collector. Thereafter, the laminated body consisting of the negative electrode current collector and the negative electrode active material layer were punched out into a size of 1 cm² to obtain a negative electrode laminated body.

### Preparation of Solid Electrolyte Layer

64.8 mg of sulfide solid electrolyte (Li₂S—P₂S₅-based glass ceramics containing LiI, D50=2.5 μm) was placed in a cylindrical ceramic with an internal diameter cross-sectional area of 1 cm², smoothed, and then pressed at 1 ton/cm² to produce a solid electrolyte layer.

### Preparation of Battery

The positive electrode laminated body was placed on one side of the solid electrolyte layer and the negative electrode laminated body was placed on the other side, and there were pressed at 6 ton/cm² for 1 min. It is note that each laminated body was arranged so that the positive electrode active material layer and the negative electrode active material layer were in contact with the solid electrolyte layer. Stainless steel rods were then placed at both electrodes and restrained with 1 ton to obtain an all-solid-state lithium ion battery of Comparative Example 1.

### EXAMPLE 1

An all-solid-state lithium ion battery of Example 1 was obtained in the same manner as Comparative Example 1, except that the layered rock salt type electrode active material of Production Example 1 was used in the preparation step of the coated positive electrode active material.

### EXAMPLE 2

An all-solid-state lithium ion battery of Example 2 was obtained in the same manner as Comparative Example 1, except that the layered rock salt type electrode active material of Production Example 2 was used in the preparation step of the coated positive electrode active material, and a ratio of a mass of the conductive aid to a mass of the solid electrolyte (conductive aid/solid electrolyte), and a mass of the solid electrolyte to a total mass of the positive electrode active material and the solid electrolyte (solid electrolyte/(positive electrode active material+solid electrolyte)) was changed as described in Table 1 in the preparation step of the positive electrode mixture.

### EXAMPLES 3 to 5

An all-solid-state lithium ion battery of Examples 3 to 5 were obtained in the same manner as Example 2, except that conductive aid/solid electrolyte, and solid electrolyte/(positive electrode active material+solid electrolyte) were changed as described in Table 1 in the preparation step of the positive electrode mixture.

### COMPARATIVE EXAMPLES 2 AND 3

An all-solid-state lithium ion battery of Comparative Examples 2 and 3 were obtained in the same manner as Comparative Example 1, except that the layered rock salt type electrode active material of Comparative Production Example 2 was used in the preparation step of the coated positive electrode active material, and conductive aid/solid electrolyte was changed as described in Table 1 in the preparation step of the positive electrode mixture.

### EXAMPLE 6

An all-solid-state lithium ion battery of Example 6 was obtained in the same manner as Comparative Example 1, except that the layered rock salt type electrode active material of Production Example 3 was used in the preparation step of the coated positive electrode active material, and conductive aid/solid electrolyte, and solid electrolyte/(positive electrode active material+solid electrolyte) were changed as described in Table 1 in the preparation step of the positive electrode mixture.

### EXAMPLES 7 AND 8

In the step of preparing the positive electrode mixture, all solid lithium ion batteries of Examples 7 and 8 were obtained in the same manner as in Example 6, except that the conductive aid/solid electrolyte, and the solid electrolyte/(positive electrode active material+solid electrolyte) were changed as described in Table 1

### COMPARATIVE EXAMPLE 4

An all-solid-state lithium ion battery of Comparative Example 4 was obtained in the same manner as in Comparative Example 1, except that the layered rock salt type electrode active material of Comparative Production Example 3 was used in the preparation step of the coated positive electrode active material, and conductive aid/solid electrolyte was changed as described in Table 1 in the preparation step of the positive electrode mixture.

### COMPARATIVE EXAMPLES 5 and 6

An all-solid-state lithium ion battery of Comparative Examples 5 and 6 were obtained in the same manner as in Comparative Example 4, except that conductive aid/solid electrolyte was changed as described in Table 1 in the preparation step of the positive electrode mixture.

### EVALUATION

### D50 particle Size of Layered Rock Salt Type Electrode Active Material

A D50 particle size of the layered rock salt type electrode active material was measured as follows: a particle size distribution of the layered rock salt type electrode active material was obtained using a laser diffraction scattering particle size distribution measuring device LA-920 (manufactured by Horiba, Ltd.); and the D50 particle size was calculated as a particle size such that when the particle size is divided into a larger side and a smaller side from a certain particle size in the obtained particle size distribution, the number of particles of the larger side and smaller side was equal. The results are shown in Table 1.

### Particle Distance of Layered Rock Salt Type Positive Electrode Active Material

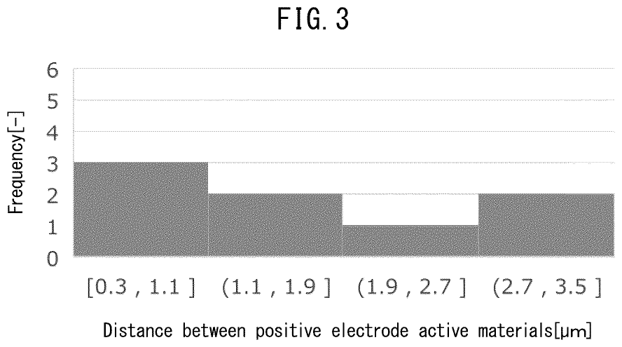

By image analysis using a cross-sectional SEM image obtained by SEM, a distribution of a distance between the centroids of the layered rock salt type electrode active material as the positive electrode active material was expressed as a histogram, and the average distance calculated based on this histogram was determined as the distance between active materials. Results are shown in FIGS. 2 and 3.

### Evaluation of Battery Resistance

For the all-solid-state lithium-ion batteries in each example, two cycles of constant current-constant voltage charge and discharge were performed at a set voltage 2.8 V or 1.5 V at a ⅓ C rate, and then SOC was adjusted to 40% at a ⅓ C rate. The battery was discharged with a direct current corresponding to a 2.5 C rate in a thermostatic bath kept at 25° C., and the resistance value was calculated from the voltage drop amount after 5 seconds using the voltage of at 0 seconds as an initial value and the applied current. The measured results are shown in Table 1, with the resistance value according to Comparative Example 1 as a reference (1.00) and the resistance value according to other examples as relative values.

### Results

The positive electrode active material (layered rock salt type electrode active material), the D 50 particle diameter of the positive electrode active material, conductive aid/solid electrolyte, solid electrolyte/(positive electrode active material+solid electrolyte), the resistance value, and the volumetric energy density are shown in Table 1

TABLE 1

| | | | | Solid electrolyte/ | | |
|---|---|---|---|---|---|---|
| | | Positive | Conductive | (Positive electrode | Resistance | Volumetric |
| | Positive | electrode | aid/Solid | active material + | value | energy |
| | electrode | active material | electrolyte | Solid electrolyte) | (relative | density |
| | active material | D50 [μm] | [% by mass] | [% by mass] | value) | [Wh/L] |
| Comp. Ex. 1 | Comp. Prod. Ex. 1 | 2.0 | 10.8 | 10 | 1.00 | 342.3 |
| Ex. 1 | Prod. Ex. 1 | 2.5 | 10.8 | 10 | 0.57 | 342.3 |
| Ex. 2 | Prod. Ex. 2 | 3.0 | 2.1 | 16 | 0.50 | 351.6 |
| Ex, 3 | Prod. Ex. 2 | 3.0 | 3.6 | 10 | 0.45 | 351.3 |
| Ex. 4 | Prod. Ex. 2 | 3.0 | 7.2 | 10 | 0.43 | 350.4 |
| Ex. 5 | Prod. Ex. 2 | 3.0 | 10.8 | 10 | 0:43 | 349.6 |
| Comp. Ex. 2 | Comp. Prod. Ex. 2 | 3.0 | 14.4 | 10 | 0.42 | 339.5 |
| Comp. Ex. 3 | Comp. Prod. Ex. 2 | 3.0 | 18.0 | 10 | 0.41 | 337.8 |
| Ex. 6 | Prod. Ex. 3. | 4.0 | 2.1 | 16 | 0.59 | 343.9 |
| Ex. 7 | Prod. Ex. 3 | 4.0 | 3.6 | 10 | 0.54 | 343.6 |
| Ex. 8 | Prod. Ex. 3 | 4.0 | 10.8 | 10 | 0.47 | 342.3 |
| Comp. Ex. 4 | Comp. Prod. Ex. 3 | 5.0 | 3.6 | 10 | 0.70 | 333.5 |
| Comp. Ex. 5 | Comp. Prod. Ex. 3 | 5.0 | 10.8 | 10 | 0.54 | 331.8 |
| Comp. Ex. 6 | Comp. Prod. Ex. 3 | 5.0 | 18.0 | 10 | 0.52 | 330.2 |

As shown in Table 1, in the batteries of the Examples in which the D50 particle size of the positive electrode active material was small and the ratio of the mass of the conductive aid to the mass of the sulfide solid electrolyte was within a predetermined range, the resistance value was low and the volumetric energy density was high. In particular, in Examples 2 to 5 in which the D50 particle size of the positive electrode active material was 3.0 μm, the resistance value was lower and volumetric energetic density was higher. In contrast, in the battery of Comparative Example 1, in which the D50 particle size of the positive electrode active material was smaller than the range of the present disclosure, the resistance value was the highest. In the batteries of Comparative Examples 2 and 3 in which although the D50 particle size of the positive electrode active material was within the range of the present disclosure, the ratio of the mass of the conductive aid to the mass of the sulfide solid electrolyte was large, the volumetric energy density was low. In addition, in the batteries of Comparative Examples 4 to 6 in which the D50 particle size of the positive electrode active material was large, the resistance value was relatively high. When the D50 particle size of the positive electrode active material was large, as in Comparative Example 4, even if the ratio of the mass of the conductive aid to the mass of the sulfide solid electrolyte was small, the volumetric energy density of the battery was low.

### DESCRIPTION OF REFERENCE SIGNS

100 Solid-state battery
110 Positive electrode current collector layer
120 Positive electrode active material layer
130 Solid electrolyte layer
140 Negative electrode active material layer
150 Negative electrode current collector layer

1. An electrode mixture, comprising a layered rock salt type electrode active material, a sulfide solid electrolyte, and a conductive aid,
wherein a D50 particle size of the layered rock salt type electrode active material is 2.5 μm or more and 4.5 μm or less, and
wherein a ratio of a mass of the conductive aid to a mass of the sulfide solid electrolyte is 2.0% by mass or more and 11.0% by mass or less.

2. The electrode mixture according to claim 1, wherein a ratio of a mass of the sulfide solid electrolyte to a total mass of the layered rock salt type electrode active material and the sulfide solid electrolyte is 10% by mass or more and 20% by mass or less.

3. The electrode mixture according to claim 1, wherein the conductive aid is fibrous carbon.

4. The electrode mixture according to claim 1, wherein the layered rock salt type electrode active material has a composition shown in a following formula (1):
Liₐ(NiₓCo_{y}M_{1-x-y})O₂ (1)
(in the formula (1), a, x, y and 1-x-y are numbers that meet 1.00≤a≤1.20, 0.30≤x ≤0.90, 0.10≤y≤0.35, and 0<1-x-y≤0.10, respectively, and M is a metallic element selected from aluminum and manganese).

5. The electrode mixture according to claim 1, wherein the layered rock salt type electrode active material comprises lithium, nickel, aluminum, and manganese.

6. A solid-state battery,
wherein the solid-state battery comprises a positive electrode current collector layer, a positive electrode active material layer, a solid electrolyte layer, a negative electrode active material layer, and a negative electrode current collector layer in this order, and wherein either one of the positive electrode active material layer and the negative electrode active material layer comprise the electrode mixture according to claim 1.

7. The solid-state battery according to claim 6, wherein the positive electrode active material layer comprises the electrode mixture.

8. The solid-state battery according to claim 7, wherein the negative electrode active material layer comprises a negative electrode active material having a silicon element.
